(19) United States
(12) Patent Application Publication
(10) Pub. No.: US 2023/0359386 A1
(43) Pub. Date: Nov. 9, 2023

(54) SYSTEMS AND METHODS FOR HIGH VOLUME DATA EXTRACTION, DISTRIBUTED PROCESSING, AND DISTRIBUTION OVER MULTIPLE CHANNELS

(71) Applicant: JPMORGAN CHASE BANK, N.A., New York, NY (US)

(72) Inventors: Arnab SAHA, Kolkata (IN); Madhu BANGALORE, Bournemouth (GB); Lawrence Charles DRAKE, Bournemouth (GB); Mahendrasinh YADAV, Bournemouth (GB); Max KENNY, Bournemouth (GB)

(21) Appl. No.: 17/662,137

(22) Filed: May 5, 2022

(51) Int. Cl. G06F 3/06

(52) U.S. Cl. CPC G06F 3/0655; G06F 3/067; G06F 3/0604; G06F 3/0679

(57) ABSTRACT

A method may include: receiving, at a computer program in a distributed data processing system, a subscription request from a subscriber to receive processed data from the distributed data processing system comprising a plurality of nodes; receiving, by a receiving node of the plurality of nodes, information about data to be processed from one or more data source; determining, by the receiving node, a number of worker nodes needed to process the data based on the information about the data; breaking, by the receiving node, the data into plurality of data chunks based on the number of worker nodes; distributing, by the receiving node, the data chunks to the worker nodes; processing, by the worker nodes, the data chunks; receiving, by a gathering node of the plurality of nodes, the processed data; and distributing, by the gathering node, the processed data to the subscriber.

### BACKGROUND OF THE INVENTION

### 1. Field of the Invention

Embodiments relate generally to systems and methods for high volume data extraction, distributed processing using application framework to implement map reduce algorithm, and distribution over multiple channels.

### 2. Description of the Related Art

Large scale data extraction is a brittle approach and does not scale well. With the ever-increasing volume of data load, current systems are incapable of scaling. As the data load continues to increase, current methods are incapable of efficiently and effectively processing this data.

### SUMMARY OF THE INVENTION

Systems and methods for high volume data extraction, distributed processing using application framework to implement map reduce algorithm, and distribution over multiple channels are disclosed. In one embodiment, a method for high volume data extraction, distributed processing, and distribution over multiple channels may include: (1) receiving, at a computer program in a distributed data processing system, a subscription request from a subscriber to receive processed data from the distributed data processing system comprising a plurality of nodes; (2) receiving, by a receiving node of the plurality of nodes, information about data to be processed from one or more data source; (3) determining, by the receiving node in the distributed data processing system, a number of worker nodes needed to process the data based on the information about the data; (4) breaking, by the receiving node, the data into plurality of data chunks based on the number of worker nodes; (5) distributing, by the receiving node, the data chunks to the worker nodes; (6) processing, by the worker nodes, the data chunks; (7) receiving, by a gathering node of the plurality of nodes, the processed data; and (8) distributing, by the gathering node, the processed data to the subscriber.

In one embodiment, the subscription request may include an identification of a type of the processed data, an identification of a data format for receiving the processed data, and/or an identification of a data channel to receive the processed data.

In one embodiment, the type of data may include transaction-related data or account-related data.

In one embodiment, the data format may include a flat file or a message.

In one embodiment, the data channel may include a REST/HTTP channel, a MQ channel, a KAFKA channel, or a bespoke file channel.

In one embodiment, the receiving node and the gathering node may be worker nodes.

In one embodiment, the information about the data may include a size of the data and/or a type of the data.

In one embodiment, at least one of the worker nodes may process more than one data chunk.

In one embodiment, the receiving node may add an additional worker node after distributing the data chunks, and distributes at least one of the data chunks to the additional worker node.

According to another embodiment, a system may include a distributed data processing system comprising a plurality of nodes; at least one data source; and a subscriber. A computer program in the distributed data processing system may receive a subscription request from the subscriber to receive processed data from the distributed data processing system. A receiving node of the plurality of nodes may receive information about data to be processed from the at least one data source, may determine a number of worker nodes needed to process the data based on the information about the data; may break the data into plurality of data chunks based on the number of worker nodes of the plurality of nodes in the distributed data processing system; and may distribute the data chunks to the worker nodes. The worker nodes may process the data chunks. A gathering node of the plurality of nodes may gather the processed data and may distribute the processed data to the subscriber.

In one embodiment, the subscription request may include an identification of a type of the processed data, an identification of a format for receiving the processed data, and/or an identification of a data channel to receive the processed data.

In one embodiment, the type of data may include transaction-related data or account-related data.

In one embodiment, the data format may include a flat file or a message.

In one embodiment, the data channel may include a REST/HTTP channel, a MQ channel, a KAFKA channel, or a bespoke file channel.

In one embodiment, the receiving node and the gathering node may be worker nodes.

In one embodiment, the information about the data may include a size of the data and/or a type of the data.

In one embodiment, at least one of the worker nodes may process more than one data chunk.

In one embodiment, the receiving node may add an additional worker node after distributing the data chunks, and distributes at least one of the data chunks to the additional worker node.

According to another embodiment, a non-transitory computer readable storage medium, may include instructions stored thereon, which when read and executed by one or more computers cause the one or more computers to perform steps comprising: receive a subscription request from a subscriber to receive processed data from a distributed data processing system; receive information about data to be processed from the at least one data source; determine a number of worker nodes needed to process the data based on the information about the data; break the data into plurality of data chunks based on the number of worker nodes of the plurality of nodes in the distributed data processing system; distribute the data chunks to the worker nodes; process the data chunks; gather the processed data; and distribute the processed data to the subscriber.

In one embodiment, the subscription request may include an identification of a type of the processed data, an identification of a format for receiving the processed data, and/or an identification of a data channel to receive the processed data, wherein the type of data may include transaction-related data or account-related, wherein the data format may include a flat file or a message, and wherein the data channel may include a REST/HTTP channel, a MQ channel, a KAFKA channel, or a bespoke file channel.

In one embodiment, the non-transitory computer readable storage medium may also include instructions stored thereon, which when read and executed by one or more computers cause the one or more computers to add an additional worker node after distributing the data chunks, and distributes at least one of the data chunks to the additional worker node.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for high volume data extraction, distributed processing, and distribution over multiple channels according to an embodiment; and

FIG. 2 depicts a method for high volume data extraction, distributed processing, and distribution over multiple channels according to an embodiment.

### DETAILED DESCRIPTION OF PREFERRED EMBODIMENTS

Embodiments are generally directed to systems and methods for high volume data extraction, distributed processing, and distribution over multiple channels.

Embodiments may apply distributed data extraction logic over large data sets running across multiple nodes. Embodiments may distribute data for processing to a plurality of worker nodes, such as Java instances, using a scatter/gather algorithm, and may distribute the processed data to downstream subscribers in accordance with a subscription. The data may be distributed using any suitable channel, including (REST/HTTP, Message Queue (MQ), KAFKA, Bespoke file in S3, etc.).

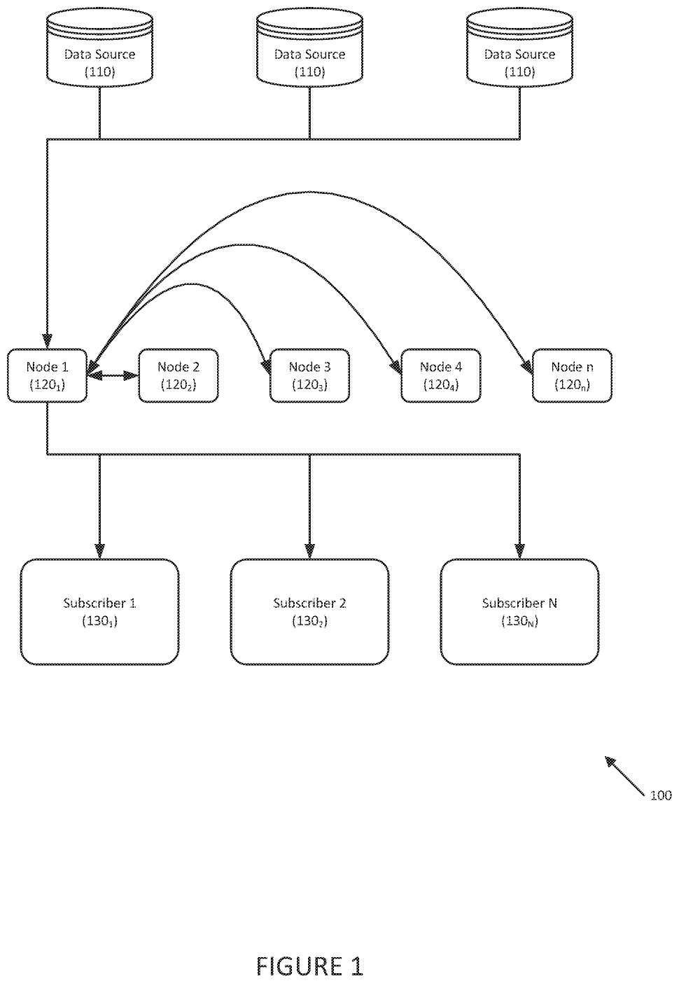

Referring to FIG. 1, a system for high volume data extraction, distributed processing, and distribution over multiple channels according to an embodiment. System 100 may include one or more data source 110. Data source 110 may be a source of any type of data, including transactional data, account-related data, etc.

Data source(s) 110 may be in communication with a plurality of nodes 120. Each node 120 may be a java instance of a virtual machine. Nodes 120 may be in a cloud environment, in a physical environment (e.g., servers), combinations thereof, etc.

One of nodes 120, such as node 120₁, may receive information about data to process from one or more data source 110. For example, the information may be a list of transactions, a list of accounts, etc. to process. In one embodiment, the information may be received by one or of nodes 120, but only one node, e.g., node 120₁, may act on the information. For example, node 120₁ may be the first node to respond to the incoming information. From the information, node 120₁ may identify a type of data (e.g., transactions, accounts, etc.), the size of the data (e.g., the number of accounts, number of transactions, etc.), and may determine the number of nodes 120 required to process the data. Node 120₁ may then separate the data into data chunks and may route the data chunks to the other nodes for processing.

Node 120₁ may also process a chunk of data.

Each node 120 may execute an instance of a computer program that controls the identification of nodes 120 to process the data and to separate the data into the chunks. The instances on the nodes may communicate with each other by a messaging protocol, such as KAFKA.

Once processing is complete, node 120₁, or any other node may determine that processing is complete and may identify one or more subscriber 130 to receive the processed data. Node 120₁ may gather the processed data, format the processed data according to subscription preferences for one or more node 130, and may distribute the processed data to one or more subscriber 130 in accordance with each subscriber 130's preferences.

In one embodiment, the processed data may be provided as a file, as streaming data, etc. The processed data may be pulled from storage (e.g., object stores, cloud storage, etc.) (not shown).

Subscribers 130 may be consumers of the processed data and may receive the processed data as a stream, or may retrieve the processed data from storage. Subscribers 130 may then reformat or transform the processed data into any format required for the subscriber.

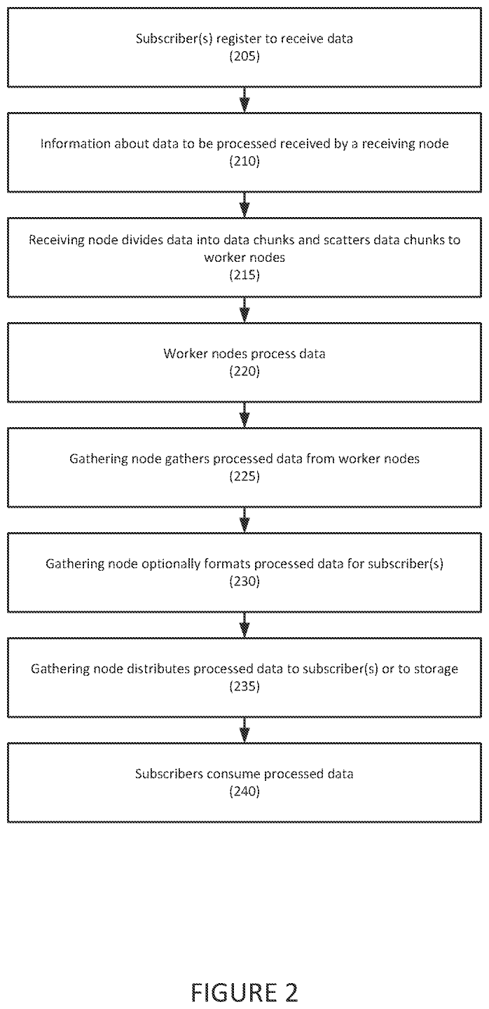

Referring to FIG. 2, a method for high volume data extraction, distributed processing, and distribution over multiple channels according to an embodiment.

In step 205, one or more subscribers may subscribe to receive processed data from a data processing system comprising a plurality of nodes. In embodiments, a subscriber may identify the type of data it is subscribing to receive, the format of the data, and the data channel to receive the data from. Examples of types of data may include transaction-related data, account-related data, etc. Examples of data formats may include flat files, KAFKA messaging, etc. Examples of data channels may include REST/HTTP, MQ, KAFKA, Bespoke file in S3, etc.).

In step 210, one or more nodes in a data processing system may receive information about data to be processed from one or more data source. In one embodiment, the data may be received in any format. In one embodiment, the information may identify a type of data (e.g., transactions, accounts, etc.), a size of data (e.g., a number of transactions, a number of accounts, etc.), etc. The information may be provided by a streaming messaging service, such as KAFKA.

In step 215, one of the nodes (e.g., a receiving node) may receive the information and may determine the type of data and the number of worker nodes needed to process the data. For example, the size of the data may determine the number of worker nodes needed to process the data.

In one embodiment, the first available node to “pick up” the information may process the information.

The receiving node may break the data into a plurality of chunks, such as one data chunk for each node, and may distribute the data chunks to the nodes.

In one embodiment, the receiving node may also process the data as a worker node.

In one embodiment, during processing, additional nodes may be added to process the data in a cloud environment. For example, any node may identify a need for additional node(s) and may spin up the as needed.

In step 220, the worker nodes may process the data. In one embodiment, each worker node may process more than one chunk of data.

In step 225, once the data processing is complete, in step 225, one of the nodes (e.g., a gathering node) may receive and gather the processed data. The gathering node may be the same as the receiving node, or it may be a different node.

In step 230, the gathering node may optionally format the processed data for one or more subscriber according to the subscriber's preferences.

In step 235, the gathering node may distribute the processed data to the subscriber(s) using the data channel specified by the subscriber. For example, the gathering node may stream the processed data using a messaging service such as KAFKA, may store the processed data in storage (e.g., object store, cloud storage, etc.), etc.

In step 240, the subscriber(s) may receive the processed data and may consume the processed data. For example, a subscriber may receive a stream of the processed data, may pull the processed data from storage, etc.

Although multiple embodiments have been described, it should be recognized that these embodiments are not exclusive to each other, and that features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for high volume data extraction, distributed processing, and distribution over multiple channels, comprising:
receiving, at a computer program in a distributed data processing system, a subscription request from a subscriber to receive processed data from the distributed data processing system comprising a plurality of nodes;
receiving, by a receiving node of the plurality of nodes, information about data to be processed from one or more data source;
determining, by the receiving node, a number of worker nodes needed to process the data based on the information about the data;
breaking, by the receiving node, the data into plurality of data chunks based on the number of worker nodes;
distributing, by the receiving node, the data chunks to the worker nodes;
processing, by the worker nodes, the data chunks;
receiving, by a gathering node of the plurality of nodes, the processed data; and
distributing, by the gathering node, the processed data to the subscriber.

2. The method of claim 1, wherein the subscription request comprises an identification of a type of the processed data, an identification of a data format for receiving the processed data, and/or an identification of a data channel to receive the processed data.

3. The method of claim 2, wherein the type of data comprises transaction-related data or account-related data.

4. The method of claim 2, wherein the data format comprises a flat file or a message.

5. The method of claim 2, wherein the data channel comprises a REST/HTTP channel, a MQ channel, a KAFKA channel, or a bespoke file channel.

6. The method of claim 1, wherein the receiving node and the gathering node are worker nodes.

7. The method of claim 1, wherein the information about the data comprises a size of the data and/or a type of the data.

8. The method of claim 1, wherein at least one of the worker nodes processes more than one data chunk.

9. The method of claim 1, wherein the receiving node adds an additional worker node after distributing the data chunks, and distributes at least one of the data chunks to the additional worker node.

10. A system, comprising:
a distributed data processing system comprising a plurality of nodes;
at least one data source; and
a subscriber;
wherein:
a computer program in the distributed data processing system receives a subscription request from the subscriber to receive processed data from the distributed data processing system;
a receiving node of the plurality of nodes receives information about data to be processed from the at least one data source;
the receiving node determines a number of worker nodes needed to process the data based on the information about the data;
the receiving node breaks the data into plurality of data chunks based on the number of worker nodes of the plurality of nodes in the distributed data processing system;
the receiving node distributes the data chunks to the worker nodes;
the worker nodes process the data chunks;
a gathering node of the plurality of nodes gathers the processed data; and
the gathering node distributes the processed data to the subscriber.

11. The system of claim 10, wherein the subscription request comprises an identification of a type of the processed data, an identification of a format for receiving the processed data, and/or an identification of a data channel to receive the processed data.

12. The system of claim 11, wherein the type of data comprises transaction-related data or account-related data.

13. The system of claim 11, wherein the data format comprises a flat file or a message.

14. The system of claim 11, wherein the data channel comprises a REST/HTTP channel, a MQ channel, a KAFKA channel, or a bespoke file channel.

15. The system of claim 10, wherein the receiving node and the gathering node are worker nodes.

16. The system of claim 10, wherein the information about the data comprises a size of the data and/or a type of the data.

17. The system of claim 10, wherein at least one of the worker nodes processes more than one data chunk.

18. The system of claim 10, wherein the receiving node adds an additional worker node after distributing the data chunks, and distributes at least one of the data chunks to the additional worker node.

19. A non-transitory computer readable storage medium, including instructions stored thereon, which when read and executed by one or more computers cause the one or more computers to perform steps comprising:
receive a subscription request from a subscriber to receive processed data from a distributed data processing system;
receive information about data to be processed from at least one data source;
determine a number of worker nodes needed to process the data based on the information about the data;
break the data into a plurality of data chunks based on the number of worker nodes of the plurality of nodes in the distributed data processing system;
distribute the data chunks to the worker nodes;
process the data chunks;
gather the processed data; and
distribute the processed data to the subscriber.

20. The non-transitory computer readable storage medium of claim 19, further including instructions stored thereon, which when read and executed by one or more computers cause the one or more computers to add an additional worker node after distributing the data chunks, and distributes at least one of the data chunks to the additional worker node.
